(19) United States
(12) Patent Application Publication
(10) Pub. No.: US 2014/0195986 A1
(43) Pub. Date: Jul. 10, 2014

(54) CONTACTLESS REMOTE CONTROL SYSTEM AND METHOD FOR MEDICAL DEVICES

(71) Applicants: Junbo Li, Shanghai (CN); Yinan Chen, Shanghai (CN); Yunrong Zhang, Shanghai (CN); Zach Forbes, Shanghai (CN)

(72) Inventors: Junbo Li, Shanghai (CN); Yinan Chen, Shanghai (CN); Yunrong Zhang, Shanghai (CN); Zach Forbes, Shanghai (CN)

(73) Assignee: KONINKLIJKE PHILIPS N.V., EINDHOVEN (NL)

(21) Appl. No.: 14/241,097

(22) PCT Filed: Aug. 17, 2012
(86) PCT No.: PCT/IB2012/054194

§ 371 Date: Feb. 26, 2014

(30) Foreign Application Priority Data
Sep. 7, 2011 (CN) CN2011/079401

(51) Int. Cl. G06F 3/0481; G06F 3/0484

(52) U.S. Cl. CPC G06F 3/04812; G06F 3/04842
USPC 715/862

(57) ABSTRACT

The present invention provides a contactless remote control system enabling an operator to operate one or more medical devices in a contactless way, said remote control system comprising a display device for displaying a Graphic User Interface GUI regarding the one or more medical devices; a tracking device for tracking the motion information of the operator; a control device for (1) interpreting the motion information of the operator into operation information relating to the movement trajectory of a cursor in the GUI or the confirmation of the selection of an item in the GUI where the cursor locates, and for (2) operating the GUI in accordance with the operation information so as to generate control commands for the one or more medical devices; and an output device for outputting the control commands to the one or more medical devices. This system of the present invention enables the operator to operate and control the medical device in a more convenient way, and causes the degree of user satisfaction to be improved.

### FIELD OF THE INVENTION

The invention relates to contactless remote control, particularly to a contactless remote control system and method for an operator, enabling him to operate one or more medical devices in a contactless way.

### BACKGROUND OF THE INVENTION

Medical devices without physical contact with patients are usually not sterilized after usage. This sometimes is very inconvenient to clinicians if they need to operate the medical devices outside the sterilized field or touch the non-sterilized devices with their clean hands.

For example, in a common clinical environment, the clinicians need to use a lot of non-sterilized medical devices. Sometimes they have to step outside the sterilized field to reach the devices and then go back to treat the patient. This may break the sterility and increase the risk of patient infection. This also increases the clinician's burden of re-sterilizing.

To maintain the sterility of medical devices, clinicians either have to re-sterilize them after touching them, or put on an extra pair of gloves, or ask an assistant to operate the devices under authority of the respective clinician. Those approaches are inconvenient and will increase the total cost in terms of operating time, materials or staff. For example, if the clinician asks an assistant to operate the devices under authority of the clinician, long-time training of the assistant and cooperation between clinician and assistant are required in order for the device to be properly manipulated according to the wishes of the clinician.

In view of the above, human motion detection and gesture recognition, which has been intensively investigated for a long time, has been used in the realm of clinical medicine.

For example, U.S. Pat. No. 7,698,002 proposes a user interface and identification system integrated with medical devices. This patent discloses a method of controlling a medical device, which comprises receiving a gesture, processing the received gesture and comparing the gesture to gestures from a gesture database comprising a plurality of gestures and a plurality of commands for the medical device; identifying one of the plurality of commands from the gesture database corresponding to the received gesture; and executing the command.

This method enables the operator to control the medical device in a contactless way, which contributes to patient infection prevention. However, this method still has several disadvantages.

First, since, as mentioned above, it is necessary to process the received gesture and compare the gesture to gestures from a gesture database comprising a plurality of gestures and a plurality of commands for the medical device, the accuracy of correctly translating the received gesture into the operator's desired command may not be guaranteed.

Further, U.S. Pat. No. 7,698,002 only discloses a method of controlling one medical device, and the inventors thereof did not consider or think of the necessity for a contactless remote control system which can control more than one medical device. In this case, the method disclosed in said patent may not be applicable any more since the number of commands for a plurality of medical devices may be tremendous. On the one hand, it is very difficult and inconvenient for the operator to memorize all these gestures corresponding to all these commands. On the other hand, since some particular gestures corresponding to certain commands may be quite similar and hard to distinguish due to the large number of commands, it may be more difficult to implement the step of processing the received gesture and comparing the gesture to gestures from a database, and accordingly the accuracy of translating the received gesture into the desired command may be further reduced.

### SUMMARY OF THE INVENTION

In view of the above problems in the prior art, the inventors of the present invention have realized that there is a need for a contactless remote control system, in which the controls for all the medical devices are integrated into one control console and which can help the operator to accurately control more than one medical device in a more convenient way.

Specifically, according to one aspect of the present invention, there is provided a contactless remote control system for an operator, enabling him to operate one or more medical devices in a contactless way, comprising:

a display device for displaying a Graphic User Interface GUI regarding the one or more medical devices;

a tracking device for tracking the motion information of the operator;

a control device for (1) interpreting the motion information of the operator into operation information relating to the movement trajectory of a cursor in the GUI or the confirmation of the selection of an item in the GUI where the cursor locates, and for (2) operating the GUI in accordance with the operation information so as to generate control commands for the one or more medical devices; and

an output device for outputting the control commands to the one or more medical devices.

The contactless remote control system of the present invention utilizes a display device for displaying a Graphic User Interface GUI regarding the medical devices, so that the control device of the system does not need to compare the gesture to a gesture in the gesture database comprising a plurality of gestures and a plurality of commands for the medical device. Instead, the present invention allows the operator to visually operate the GUI in accordance with his/her motion so as to generate control commands for the medical devices.

Since the operator is able to operate the GUI in a visual way and control the medical device accordingly, there is no need for the operator to memorize all the gestures corresponding to all these commands and therefore the operator may operate and control the medical device in a more convenient way and the degree of user satisfaction is improved.

According to an embodiment of the present invention, the GUI displayed by the display device shows the one or more medical devices as selectable items when the system is activated.

In accordance with the present embodiment, all the operable medical devices are shown on the display device and the operator can remotely select the medical device he wants to operate by performing a respective motion, for example, by moving his finger in the air, as if he were operating a virtual touch screen. As a result, the contactless remote control system, in which the controls for all the medical devices are integrated into one control console, is achieved.

According to a further embodiment, the GUI further shows all the control items for a medical device when the operation information indicates that said medical device is selected, and the control device generates control commands for said medical device in accordance with the operation information regarding said control items.

In accordance with the present embodiment, the GUI displayed by the display device further shows all the control items for a medical device when the operation information indicates that said medical device is selected. For example, the control items shown by the GUI may comprise all kinds of control parameters and status of the selected medical device. In this case, the operator may visually adjust or manipulate these control parameters and status by performing the respective motions.

Since the operator is able to visually operate the medical device through all kinds of controllable items for the medical device, the operator may operate the medical device in a more accurate way, because he can confirm whether the adjusted parameters or status shown on the GUI represent the desired commands at any moment.

According to an embodiment of the present invention, the system may be activated by particular motion information of the operator or by pressing down an activation button on the system. The activation button on the system may be sterilized in advance so that the patient will not run the risk of infection.

According to another aspect of the present invention, there is provided a medical device, which comprises an input device for receiving the control commands output by the system according to the present invention, and the medical device is characterized in that it can be operated in a dual-control mode.

Specifically, the dual-control mode may include the conventional manual operation mode and the remote control mode. The medical device is different from conventional medical devices in that the operation mode thereof may be changed from conventional manual operation mode to remote control mode upon the reception of the control commands by the input device.

According to another aspect of the present invention, there is provided a contactless remote control method enabling an operator to operate one or more medical devices in a contactless way, comprising the steps of:

tracking the motion information of the operator;

interpreting the motion information of the operator into operation information relating to the movement trajectory of a cursor in a GUI displayed on a display device or the confirmation of the selection of an item in the GUI where the cursor locates;

operating the GUI in accordance with the operation information so as to generate control commands for the one or more medical devices; and

outputting the control commands to the one or more medical devices.

These and other objects of the invention will be apparent from the following description taken in connection with the drawings.

### DESCRIPTION OF THE DRAWINGS

The present invention will be described and explained hereinafter in more detail by means of embodiments and with reference to the drawings, in which:

FIG. 1 shows the principle of the contactless remote control system according to the present invention;

FIG. 2 is a block diagram of the contactless remote control system according to an embodiment of the present invention; and

FIG. 3 is a flowchart of the contactless remote control method according to an embodiment of the present invention.

The same reference signs in the figures indicate similar or corresponding features and/or functionalities.

### DETAILED DESCRIPTION

The embodiment of the present invention will be described hereinafter in more detail with reference to the drawings.

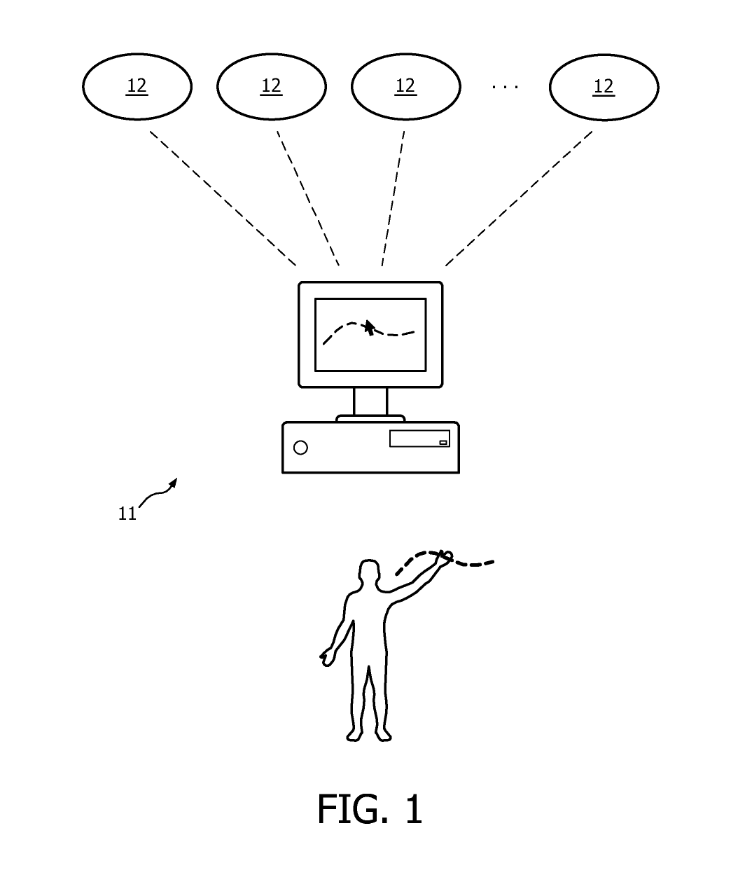

FIG. 1 shows the principle of the contactless remote control system 11 according to the present invention.

As can be seen from FIG. 1, the contactless remote control system 11 is hibernated initially. One or more medical devices 12 could be manually controlled in the conventional way. When necessary, the contactless remote control system 11 can be “woken up” by pushing a sterilized button disposed on the system 11 or by means of a specified hand gesture by the operator.

Although not shown in this figure, a tracking device, such as an optical or infrared camera, is used to track the motion information of the operator, for example a clinician. As is well-known in the art, the motion information of the operator may be the motion information of the operator's hand, but is not limited thereto. Further, active optical or infrared markers may be attached to the operator. The ROI of the camera will be automatically adjusted to focus on the operator by tracking the active markers, so that the motion of the operator will not be interfered with by other people in the room.

At first, all controllable medical devices 12 are shown as selectable icons or buttons on the GUI displayed on a display device of the contactless remote control system 11. The display device could be a separate device or could be combined with one medical device 12.

With the system according to the present invention, the operator can perform a motion to choose the medical device 12 he wants to operate. In one example, as shown in FIG. 1, the operator can remotely select the medical device he wants to operate by moving a finger in the air, as if he is operating a virtual touchscreen. The motion information of the operator's hand or finger directly corresponds to the movement trajectory of a cursor in the GUI or the confirmation of the selection of an item in the GUI where the cursor locates.

When one medical device 12 is selected, another GUI is shown on the display device to illustrate the control parameters and status of the selected medical device 12. The operator can remotely manipulate the medical device 12 using hand movement and gestures.

Similarly, the operator could go back to select another medical device 12 and operate it remotely. The operator can also switch off the remote control mode and operate the medical devices 12 in the conventional manual way if necessary.

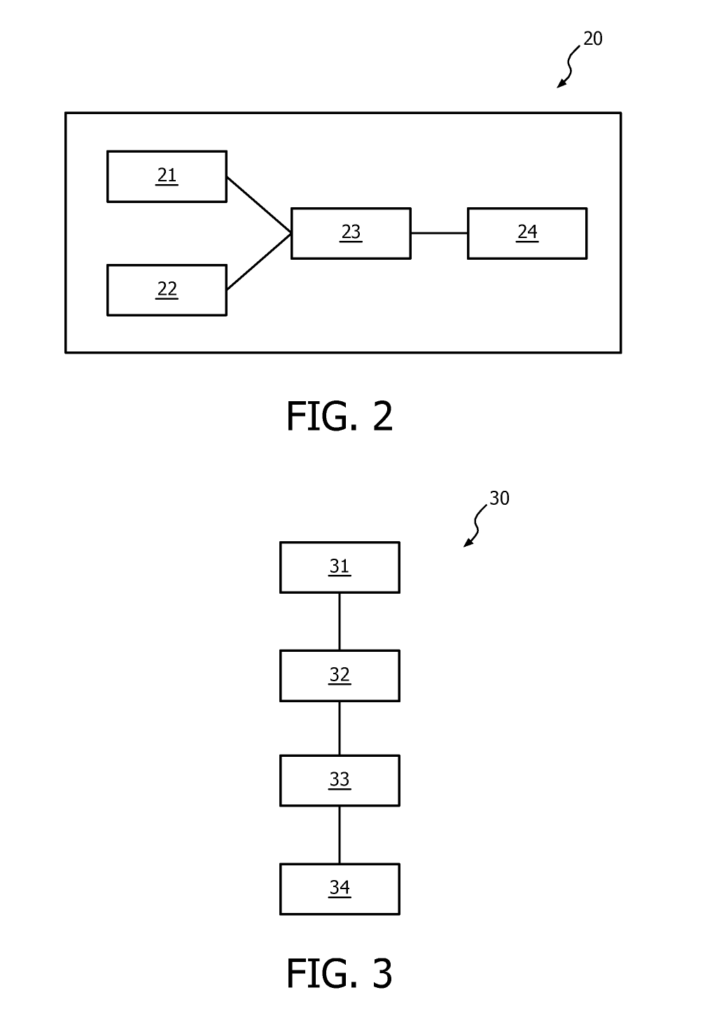

FIG. 2 is a block diagram of the contactless remote control system 11 according to an embodiment of the present invention. The operation details of the system according to the present invention will be described in conjunction with FIG. 2.

As can be seen from FIG. 2, the system 11 comprises a display device 21 for displaying a Graphic User Interface GUI regarding the one or more medical devices 12. The display device 21 could be a separate device or could be combined with one medical device 12.

The system 11 further comprises a tracking device 22 for tracking the motion information of the operator.

As mentioned above, the tracking device 22 may be, for example, an optical or infrared camera. However, it should be noted that, as will be easily understood by the person skilled in the art, any tracking device, other than the optical or infrared camera, capable of tracking the motion information of the operator may be used.

In a preferred embodiment of the present invention, to improve the performance of the system 11, at least one active optical or infrared marker (not shown) may be attached to the operator. In this case, the ROI of the camera will be automatically adjusted to focus on the operator by tracking the active markers, so that the motion of the operator will not be interfered with by other people in the room.

The system 11 further comprises a control device 23, which may be for example a central processor unit or a central controller unit in a computer. The control device 23 is connected to the display device 21 and the tracking device 22, and is in communication therewith.

When the control device 23 receives the motion information of the operator from the tracking device 22, the control device 23 first interprets the motion information of the operator into operation information relating to the movement trajectory of a cursor in the GUI or the confirmation of the selection of an item in the GUI where the cursor locates, and then operates the GUI in accordance with the operation information so as to generate control commands for the one or more medical devices 12.

The system 11 further comprises an output device 24 connected to the control device 23, for outputting the generated control commands to the one or more medical devices 12. The output device 24 may output the control commands to the medical device 12 in a wired or wireless way.

In the system 11 according to the present invention, use is made of a display device 21 for displaying a Graphic User Interface GUI regarding the medical devices 12, as a result of which the control device 23 of the system 11 does not need to compare the gesture to gestures of a gesture database comprising a plurality of gestures and a plurality of commands for the medical device. Instead, the system 11 allows the operator to operate the GUI in accordance with his/her motion in a visual way so as to generate control commands for the medical devices.

Since the operator is capable of operating the GUI in a visual way and control the medical device 12 accordingly, there is no need for the operator to memorize all these gestures corresponding to all these commands and therefore the operator may operate and control the medical device 12 in a more convenient way and hence the degree of user satisfaction is improved.

In an embodiment of the present invention, the GUI displayed by the display device 21 shows the one or more medical devices 12 as selectable items when the system 11 is activated.

In this embodiment, all the operable medical devices 12 are shown on the display device 21 and the operator can remotely select the medical device 12 he wants to operate by performing a motion, for example, by moving his finger in the air, as if he is operating a virtual touchscreen. As a result, the contactless remote control system, in which the controls for all the medical devices are integrated into one control console, is achieved.

According to a further embodiment, the GUI further shows all the control items for a medical device 12 when the operation information indicates that said medical device 12 is selected, and the control device 23 generates control commands for said medical device 12 in accordance with the operation information regarding said control items.

In accordance with the present embodiment, the GUI displayed by the display device 21 further shows all the control items for a medical device 12 when the operation information indicates that said medical device 12 is selected. For example, the control items shown by the GUI may comprise all kinds of control parameters and the status of the selected medical device. In this case, the operator may visually adjust or manipulate these control parameters and the status by performing a motion.

Since the operator is able to visually operate the medical device 12 through all kinds of controllable items for the medical device 12, the operator may operate the medical device 12 in a more accurate way, because he can confirm whether the adjusted parameters or status shown on the GUI represent his desired commands at any moment.

In the above embodiments of the present invention, the item or the control item shown on the GUI may be configured as a menu bar, icon or button. Of course, it should be understood by those skilled in the field of computer graphics, that any other form of the item could be adopted as long as it can be operated by the operator.

Further, as is well-known in the art, the motion information of the operator may be the motion information of the operator's hand, but is not limited thereto, and the control device interprets the hand gestures into operation information in accordance with the motion information of the operator's hand.

FIG. 3 is a flowchart of the contactless remote control method according to an embodiment of the present invention.

As shown in FIG. 3, the method 30 according to the present invention comprises a tracking step 31 of tracking the motion information of the operator. The function of step 31 can be executed by the tracking device 22 of the system 11 in FIG. 2.

The method 30 further comprises an interpreting step 32 of interpreting the motion information of the operator into operation information relating to the movement trajectory of a cursor in a GUI displayed on the display device 21 or the confirmation of the selection of an item in the GUI where the cursor locates. The function of step 32 can be executed by the control device 23 of the system 11 in FIG. 2.

The method 30 further comprises an operating step 33 of operating the GUI in accordance with the operation information so as to generate control commands for the one or more medical devices 12. The function of step 33 can be executed by the control device 23 of the system 11 in FIG. 2.

The method 30 further comprises an output step 34 of outputting the control commands to the one or more medical devices 12. The function of step 34 can be executed by the output device 24 of the system 11 in FIG. 2.

In a further embodiment according to the present invention, the GUI displayed by the display device shows the one or more medical devices as selectable items before the tracking step.

In a still further embodiment according to the present invention, the GUI further shows all the control items for a medical device when the operation information indicates that said medical device is selected, and the operating step comprises generating control commands for said medical device in accordance with the operation information regarding said control items.

According to another aspect of the present invention, a medical device 12 is provided which comprises an input device for receiving the control commands output by the system 11 according to the present invention and the medical device 12 is characterized in that it can be operated in a dual-control mode.

Specifically, the dual-control mode may include the conventional manual operation mode and the remote control mode. The medical device 12 is different from those conventional medical devices in that the operation mode thereof may be changed from conventional manual operation mode to remote control mode upon the reception of the control commands by the input device.

For example, the software or the hardware of the medical device 12 or the combination thereof may be updated in order that the medical device 12 can be operated in dual-control mode and can be remotely controlled by the control commands output from the system 11 when the remote control mode is on.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the system claims enumerating several units, several of these units can be embodied by one and the same item of software and/or hardware. The usage of the words first, second and third, et cetera, does not indicate any ordering. These words are to be interpreted as names.

1. A contactless remote control system for an operator to operate multiple medical devices in a contactless way, comprising:
a display device for displaying a Graphic User Interface GUI regarding the multiple medical devices;
a tracking device for tracking the motion information of the operator;
a control device for (1) interpreting the motion information of the operator into operation information relating to the movement trajectory of a cursor in the GUI or the confirmation of the selection of an item in the GUI where the cursor locates, and (2) operating the GUI in accordance with the operation information so as to select a medical device the operator wants to operate and generate control commands for the selected medical devices; and
an output device for outputting the control commands to the multiple medical devices.

2. The system according to claim 1, wherein
the GUI displayed by the display device shows the multiple medical devices as selectable items when the system is activated.

3. The system according to claim 2, wherein
the GUI further shows all the control items for a medical device when the operation information indicates that said medical device is selected, and
the control device generates control commands for said medical device in accordance with the operation information regarding said control items.

4. The system according to claim 3, wherein
the item is configured as menu bar, icon or button.

5. The system according to claim 1, wherein
the motion information of the operator is the motion information of the operator's hand, and
the control device interprets the hand gestures into operation information in accordance with the motion information of the operator's hand.

6. The system according to claim 1, wherein the tracking device comprises an optical or infrared camera.

7. The system according to claim 6, wherein
the tracking device tracks the operator with the aid of active optical or infrared markers attached to the operator.

8. The system according to claim 1, wherein
the system is activated by particular motion information of the operator or by pressing down an activation button on the system.

9. A medical device comprising
an input device for receiving the control commands output by the system according to claim 1, wherein
the operation mode of the medical device is changed from conventional manual operation mode to remote control mode upon the reception of the control commands by the input device.

10. A contactless remote control method for an operator to operate multiple medical devices in a contactless way, comprising the steps of:
tracking the motion information of the operator;
interpreting the motion information of the operator into operation information relating to the movement trajectory of a cursor in a GUI displayed on a display device or the confirmation of the selection of an item in the GUI where the cursor locates;
operating the GUI in accordance with the operation information so as to select a medical device the operator wants to operate and generate control commands for the one or more medical devices; and
outputting the control commands to the multiple medical devices.

11. The method according to claim 10, wherein
the GUI displayed by the display device shows the multiple medical devices as selectable items before the tracking step.

12. The method according to claim 11, wherein
the GUI further shows all the control items for a medical device when the operation information indicates that said medical device is selected, and
the step of operating comprises generating control commands for said medical device in accordance with the operation information regarding said control items.

13. The method according to claim 10, wherein
the motion information of the operator is the motion information of the operator's hand, and
the step of interpreting comprises interpreting the hand gestures into operation information in accordance with the motion information of the operator's hand.

14. The method according to claim 10, wherein
the tracking step comprises tracking the motion information of the operator by an optical or infrared camera.

15. The method according to claim 14, wherein
the step of tracking comprises tracking the operator with the aid of active optical or infrared markers attached to the operator.
